(19) United States
(12) Patent Application Publication
(10) Pub. No.: US 2003/0032754 A1
(43) Pub. Date: Feb. 13, 2003

(54) Aliphatic thermoplastic polyurethanes and use thereof

(76) Inventors: Wolfgang Kaufhold, Koln (DE); Henricus Peerlings, Solingen (DE); Hans-Georg Hoppe, Leichlingen (DE); Wolfgang Rohrig, Bergisch Gladbach (DE)

Correspondence Address: BAYER CORPORATION, PATENT DEPARTMENT, 100 BAYER ROAD, PITTSBURGH, PA, 15205, US

(21) Appl. No.: 10/095,154

(22) Filed: Mar. 11, 2002

(30) Foreign Application Priority Data
Mar. 15, 2001 (DE) 10112366.3

(51) Int. Cl. C08G 18/00

(52) U.S. Cl. 528/44

(57) ABSTRACT

A thermoplastic molding composition comprising soft polyurethane is disclosed. The polyurethane is prepared by reacting, optionally in the presence of (D) a catalyst, A) hexamethylene diisocyanate (HDI), optionally along with one or more aliphatic diisocyanate other than HDI, B) a polyol having a number-average molecular weight of 2,500 to 10,000 g/mol, selected from the group consisting of polyoxypropylene glycol, polyoxyethylene glycol and copolyoxyalkylene diols based on propylene oxide and ethylene oxide, optionally along with additional, different polyols and C) a chain extender having a number-average molecular weight of 60 to 500 g/mol. The polyurethane that is characterized in that its equivalent ratio is 1.5:1.0 to 30.0:1.0, and its NCO index is 95 to 105, is suitable for making articles having reduced mechanical properties and high thermal properties.

### FIELD OF THE INVENTION

The invention relates to thermoplastic molding compositions and more especially to compositions that contain aliphatic polyurethane.

### SUMMARY OF THE INVENTION

A soft (70 to 90 Shore A hardness) aliphatic thermoplastic polyurethanes (TPUs) is disclosed. The inventive TPU is characterized by its reduced mechanical strength that is accompanied by a high heat deflection temperature and a high melting point.

### BACKGROUND OF THE INVENTION

Owing to their having being formed from aromatic diisocyanates, aromatic thermoplastic polyurethanes (aromatic TPUs) are not light-resistant. Where moldings of a specific color are produced, a strong yellowing occurs as a result of exposure to light and even in black moldings there is a change in the degree of color and gloss.

The use of aliphatic thermoplastic polyurethanes (TPUs) in the interior fittings of motor vehicles, for example, in the surface coverings of instrument panels, is already known (for example, from DE-C 42 03 307). Naturally, here there is a desire to achieve a uniform appearance over the entire surface covering and accordingly to manufacture this from a single material. The problem arises here, however, that the common aliphatic thermoplastic polyurethanes having a high resistance to light and temperature stability, by reason of their excellent mechanical properties, in particular the high tear strength, are not suitable as covering for airbags, in particular when the passenger airbag is designed as an invisible, integral component of the instrument panel.

DE-C 42 03 307 describes a polyurethane molding composition which can be thermoplastically processed into the form of sinterable powder for the production of grained sintered sheets, the molding composition consisting exclusively of linear aliphatic components. The polyol component consists of 60 to 80 parts by weight of an aliphatic polycarbonate diol having a molecular weight Mₙ of 2000 and 40 to 20 parts by weight of a polydiol based on adipic acid, hexanediol and neopentyl glycol, having a molecular weight Mₙ of 2000. In addition, 1,6-hexamethylene diisocyanate is used in an equivalent ratio of 2.8:1.0 to 4.2:1.0, based on the polyol mixture, and 1,4-butanediol is used as a chain-extending agent, the equivalent ratio of 1,4-butanediol, based on the polyol mixture, being 1.3:1.0 to 3.3:1.0. The sheets produced from these molding compositions are distinguished, inter alia, by a high tensile strength, initial tear strength and tear resistance. Polyurethane sheets having good mechanical properties, in particular a high tear strength, are also described in EP-A 399 272.

EP-A 555 393 discloses soft, aliphatic TPUs which are based on aliphatic diisocyanates (including HDI, H12-MDI) and on polyoxyalkylene glycols and have very good mechanical properties.

In EP-A 712 887 there is a general description of TPUs which are based on aliphatic diisocyanates (including HDI, H12-MDI) and on various polyether glycols and have a good resistance to light.

The object, accordingly, was to provide soft (70 to 90 Shore A hardness) TPUs which have a high resistance to light and heat deflection temperature, but exhibit a lower mechanical strength than that of the thermoplastic polyurethanes known hitherto.

Surprisingly, this object was achieved by means of the thermoplastic polyurethanes according to the invention.

### DETAILED DESCRIPTION OF THE INVENTION

The present invention provides soft, aliphatic thermoplastic polyurethanes having a Shore A hardness of 70 to 90, which are prepared, optionally using catalysts (D), from the following reactants

A) a mixture of

A1) 100 to 70 mol. % hexamethylene diisocyanate (HDI) and

A2) 0 to 30 mol. % of one or more other aliphatic diisocyanates different from HDI such as, for example, dicyclohexylmethane diisocyanate (hydrogenated MDI) or isophorone diisocyanate (IPDI),

B) a mixture of

B1) 100 to 70 wt. %, preferably 100 to 80 wt. %, of at least one polyol selected from the group consisting of polyoxypropylene glycol, polyoxyethylene glycol and copolyoxyalkylene diol based on propylene oxide and ethylene oxide, having a number-average molecular weight of 2,500 to 10,000 g/mol and

B2) 0 to 30 wt. %, preferably 0 to 20 wt. %, of one or more polyol that is different from B1) having a number-average molecular weight of 600 to 10,000 g/mol and

C) chain extenders having a number-average molecular weight of 60 to 500 g/mol, optionally with the addition of

E) conventional auxiliary substances and additives, with the equivalent ratio of diisocyanate A) to the sum of polyols B1) and B2)-herein equivalent ratio-being 1.5:1.0 to 30.0:1.0, and the NCO index (calculated by multiplying by 100 the equivalent ratio of isocyanate groups from A) to the sum of the hydroxyl groups from B) and C) being 95 to 105.

Particularly preferred aliphatic thermoplastic polyurethanes are those wherein the mixture B) consists of 100 wt. % B1) and the chain extender C) consists of 80 to 100 wt. % 1,6-hexanediol (C1) and 0 to 20 wt. % of a chain extender (C2) which is different from (C1) and has a number-average molecular weight of 60 to 500 g/mol.

Component B1) particularly preferably has a number-average molecular weight of 3,500 to 6,000 g/mol.

The TPUs according to the invention may be produced using different procedures, these variants being equally good.

The TPUs according to the invention based on two different aliphatic diisocyanates “A1” (HDI) and “A2” (aliphatic diisocyanate, different from HDI) may be produced, for example, by a reaction process leading to TPU “A1-2”. But it is also possible, in known manner, first of all to prepare the TPU “A1” based on the aliphatic diisocyanate “A1” and, separately from this, to prepare the TPU “A2” based on the aliphatic diisocyanate “A2”, the remaining components B to E being identical. Subsequently, TPU “A1” and TPU “A2” are mixed together in known manner in the required ratio to form the TPU “A1-2” (for example, using extruders or kneaders).

The TPUs according to the invention based on polyol mixtures can likewise be produced by using polyol mixtures (polyol B1 and polyol B2) (for example, in mixing units), in a reaction process leading to the TPU “B1-2”. Secondly, it is possible, in known manner, first of all to prepare the TPU “B1” based on polyol “B1” and, separately from this, to prepare the TPU “B2” based on the polyol “B2”, the remaining components A and C to E being identical. Subsequently, TPU “B1” and “B2” are mixed together in known manner in the required ratio to form the TPU “B1-2” (for example, using extruders or kneaders).

Depending on the requirements demanded of the molding to be produced from the TPU according to the invention, the hexamethylene diisocyanate (HDI) may be partially replaced by one or more other aliphatic diisocyanates, in particular isophorone diisocyanate (IPDI), 1,4-cyclohexane diisocyanate, 1-methyl-2,4-cyclohexane diisocyanate, 1-methyl-2,6-cyclohexane diisocyanate and isomeric mixtures thereof, 4,4′-,2,4′- and 2,2′-dicyclohexylmethane diisocyanate and isomeric mixtures thereof.

In the case of applications where there are lesser requirements as regards resistance to light, for example, dark-colored molding compositions, portions (0 to 20 wt. %) of the aliphatic diisocyanate may be replaced even by aromatic diisocyanates. These are described in Justus Liebigs Annalen der Chemie 562, p.75-136. Examples are 2,4-tolylene diisocyanate, mixtures of 2,4- and 2,6-tolylene diisocyanate, 4,4′-, 2,2′- and 2,4′-diphenylmethane diisocyanate, mixtures of 2,4- and 4,4′-diphenylmethane diisocyanate, urethane-modified, liquid 2,4- and/or 4,4′-diphenylmethane diisocyanates, 4,4′-diisocyanatodiphenylethane-1,2 and 1,5-naphthylene diisocyanate.

Linear hydroxyl-terminated polyols having an average molecular weight of 600 to 10,000 g/mol, preferably of 700 to 4,200 g/mol, are used as component B2). Owing to the conditions of their production, these frequently contain small quantities of non-linear compounds. For this reason, they are often also referred to as “substantially linear polyols”.

Suitable polyester diols may be prepared, for example, from dicarboxylic acids having 2 to 12 carbon atoms, preferably 4 to 6 carbon atoms, and polyhydric alcohols. Examples of suitable dicarboxylic acids are: aliphatic dicarboxylic acids, such as succinic acid, glutaric acid, adipic acid, suberic acid, azelaic acid and sebacic acid and aromatic dicarboxylic acids, such as phthalic acid, isophthalic acid and terephthalic acid. The dicarboxylic acids may be used individually or as mixtures, for example, in the form of a succinic, glutaric and adipic acid mixture. In the preparation of the polyester diols it may optionally be advantageous, in place of the dicarboxylic acids, to use the corresponding dicarboxylic acid derivatives, such carboxylic diesters having 1 to 4 carbon atoms in the alcohol group, carboxylic anhydrides or carboxylic chlorides. Examples of polyhydric alcohols are glycols having 2 to 10, preferably 2 to 6 carbon atoms, such as ethylene glycol, diethylene glycol, 1,4-butanediol, 1,5-pentanediol, 1,6-hexanediol, 1,10-decanediol, 2,2-dimethyl-1,3-propanediol, 1,3-propanediol, and dipropylene glycol. Depending on the required properties, the polyhydric alcohols may be used alone or optionally as in a mixture with one another. Moreover, esters of carbonic acid with the above-mentioned diols, in particular those having 4 to 6 carbon atoms, such as 1,4-butanediol or 1,6-hexanediol, are suitable, as are condensation products of hydroxycarboxylic acids, for example, hydroxycaproic acid, and polymerisation products of lactones, for example, optionally substituted caprolactones. Preferably used polyester diols are ethanediol polyadipates, 1,4-butanediol polyadipates, ethanediol 1,4-butanediol polyadipates, 1,6-hexanediol neopentyl glycol polyadipates, 1,6-hexanediol 1,4-butanediol polyadipates and polycaprolactones. The polyester diols have average molecular weights of 600 to 10,000, preferably of 700 to 4,200, and may be used individually or in the form of mixtures with one another.

Suitable polyether diols may be prepared by reacting one or more alkylene oxides having 2 to 3 carbon atoms in the alkylene group with a starter molecule containing two bound active hydrogen atoms. Alkylene oxides which may be mentioned are, for example: ethylene oxide, 1,2-propylene oxide and epichlorohydrin. Preferably ethylene oxide, propylene oxide and mixtures of 1,2-propylene oxide and ethylene oxide are used. The alkylene oxides may be used individually, alternating with one another, as blocks (for example, C3 ether block with C2 blocks and with predominantly primary OH groups as terminal groups) or as mixtures. Examples of suitable starter molecules are: water, amino alcohols, such as N-alkyldiethanolamines, for example, N-methyidiethanolamine, and diols, such as ethylene glycol, 1,3-propylene glycol, 1,4-butanediol and 1,6-hexanediol. Optionally, mixtures of starter molecules may also be used.

Suitable polyether diols are the hydroxyl-containing polymerization products of tetrahydrofuran. Trifunctional polyethers may also be used in proportions of 0 to 30 wt. %, based on the bifunctional polyether, but at most in a quantity such that a thermoplastically workable product is formed. The substantially linear polyether diols have molecular weights of 600 to 5,000, preferably of 700 to 4,200. They may be used either individually or in the form of mixtures with one another.

The compounds used as chain-extending agent C) are aliphatic diols or diamines having a molecular weight of 60 to 500, preferably aliphatic diols having 2 to 14 carbon atoms such as, for example, ethanediol, 1,4-butanediol, 1,6-hexanediol, diethylene glycol, dipropylene glycol or (cyclo)aliphatic diamines such as, for example, isophorone diamine, ethylenediamine, 1,2-propylenediamine, 1,3-propylenediamine, N-methylpropylene-1,3-diamine, N,N′-dimethylethylenediamine. Mixtures of the above-mentioned chain extenders may also be used. In addition, relatively small quantities of triols may also be added.

The particularly preferred chain-extending agent is 1,6-hexanediol, optionally in a mixture with up to 20 wt. % of a chain extender other than 1,6-hexanediol, having an average molecular weight of 60 to 500 g/mol.

Depending on the overall requirements, portions of the aliphatic diols and diamines (up to 20 wt. %, based on the chain extender) may be replaced by aromatic diols and diamines. Examples of suitable aromatic diols are diesters of terephthalic acid with glycols having 2 to 4 carbon atoms such as, for example, bis(ethylene glycol) terephthalate or bis(1,4-butanediol) terephthalate, hydroxyakylene ethers of hydroquinone such as, for example, 1,4-di(hydroxyethyl)hydroquinone, and ethoxylated bisphenols. Examples of suitable aromatic diamines are 2,4-tolylene-diamine and 2,6-tolylenediamine, 3,5-diethyl-2,4-tolylenediamine and 3,5-diethyl-2,6-tolylenediamine and primary mono-, di-, tri- or tetraalkyl-substituted 4,4′-diaminodiphenylmethanes.

Moreover, conventional monofunctional compounds may also be used in small quantities, for example, as chain stoppers or mold-release agents. Examples which may be mentioned are alcohols such as octanol and stearyl alcohol, or amines such as butylamine and stearylamine.

The TPUs according to the invention may also be produced by the known belt process or extruder process (GB-A 1,057,018 and DE-A 2,059,570). The process described in PCT/EP 98/07753 is preferred.

A catalyst is preferably employed in the continuous production of thermoplastic polyurethanes by the extruder process or belt process. Suitable catalysts are conventional tertiary amines known in prior art, such as, for example, triethylamine, dimethylcyclohexylamine, N-methyl-morpholine, N,N′-dimethylpiperazine, 2-(dimethylaminoethoxy)ethanol, diazabicyclo[2.2.2]octane and the like, as well as in particular organometallic compounds, such as titanate esters, iron compounds, tin compounds, for example, tin diacetate, tin dioctoate, tin dilaurate or the dialkyltin salts of aliphatic carboxylic acids, such as dibutyltin diacetate, dibutyltin dilaurate or the like. Preferred catalysts are organometallic compounds, in particular titanate esters, iron compounds or tin compounds. Dibutyltin dilaurate is most preferred.

UV stabilizers, antioxidants, auxiliary substances and additives may also be used in addition to the TPU components and optional catalysts. One may mention, for example, lubricants, such as fatty esters, metallic soaps thereof, fatty amides and silicone compounds, antiblocking agents, inhibitors, stabilizers against hydrolysis, heat and discoloration, flameproofing agents, dyes, pigments, inorganic and organic fillers and reinforcing agents, which are produced as in prior art and may also be treated with a size. More detailed information about the above-mentioned auxiliary substances and additives may be found in the specialist literature, for example, J. H. Saunders, K. C. Frisch: “High Polymers”, Volume XVI, Polyurethanes, Part 1 and 2, Interscience Publishers 1962 or 1964, R. Gächter, H. Müller (Ed.): Taschenbuch der Kunststoff-Additive, 3rd Edition, Hanser Verlag, Munich 1989 or DE-A 29 01 774.

The additives may be introduced after the polymerization by compounding, or even during the polymerization. For example, antioxidants and UV stabilisers may be dissolved in the polyol during the polymerization. Lubricants and stabilizers may also be added during the extrusion process, for example, in the second section of the screw.

The TPUs according to the invention may be used for producing moldings, in particular for producing extrudates (for example, sheets) and injection-moulded parts. In addition, the TPUs according to the invention may be used as sinterable powder for the production of flat structures and hollow bodies.

The invention is explained in more detail by means of the following Examples.

### EXAMPLES

### Production of the TPUs and Spray Plates

The TPUs were produced continuously in the following manner.

Component B), antioxidant, chain extender C) and dibutyltin dilaurate were heated to approximately 110° C. in a boiler, with stirring, and together with component A), which had been heated to approximately 110° C. by means of a heat exchanger, were intensively mixed by a static mixer (firm of Sulzer; DN6 having 10 mixing units and a shear rate of 500 s⁻¹) and then passed into the feed device of a screw (ZSK 32). The whole of the mixture underwent complete reaction in the extruder and was subsequently granulated.

The granular material produced was dried and then sprayed onto several spray plates.

### Test conditions Dynamic Mechanical Analysis (DMS)

Rectangles (30 mm×10 mm×2 mm) were punched out of the spray plates. These test plates, under constant preload—optionally dependent on the memory module—were periodically excited by very small deformations and the force acting upon the clamping device was measured as a function of the temperature and excitation frequency.

The preload additionally applied served to keep the sample adequately taut at the time of negative deformation amplitude.

The DMS measurements were carried out using the Seiko DMS model 210, from the firm of Seiko, at 1 Hz in the temperature range of −150° C. to 200° C. at a heating rate of 2° C./min.

### Tensile Test

Elongation at tear and tear strength were measured at room temperature on S1 rods (correspond to type 5 test specimens according to EN ISO 527, punched out of spray plates) in accordance with DIN 53455, at a stretching speed of 200 mm/min.

### DSC Measurement

DSC (Differential Scanning Calorimetry) is an effective method of detecting and quantifying glass temperatures and melting points as well as associated heat capacities or enthalpies of conversion.

DSC thermograms are recorded by heating up, at an identical constant rate, an aluminium pan containing 5-30 g of sample (in the present case, granular material) and an empty aluminium pan as a reference. If, as the result, for example, of endothermic conversions in the sample, there are differences in temperature from that of the reference, more heat must be supplied to the sample pan for a short time. This difference in heat flow is the analysable signal.

DSC is described in more detail, for example, in “Textbook of Polymer Science” by Fred W. Billmeyer, Jr., 3rd Edition, a Wiley-Interscience Publication.

The DSC measurements recorded here were carried out using a DSC 7 from the firm of Perkin Elmer. To this end, 5-30 mg granular material was placed in the sample pan, the sample was cooled to −70° C. and maintained there for one minute. The sample was then heated to 260° C. at a heating rate of 20° C. per minute. The melting point is the maximum of the melting peak obtained.

| | |
|---|---|
| DBTL: | dibutyltin dilaurate |
| Therathane 2000 ®: | polytetrahydrofurandiol with Mₙ = 2000 g/mol |
| | (Du Pont) |
| Therathane 1000 ®: | polytetrahydrofurandiol with Mₙ = 1000 g/mol |
| | (Du Pont) |
| Acclaim ® 2220: | polyether polyol containing polyoxypropylene- |
| | polyoxyethylene units (having approx. 85% primary |
| | hydroxyl groups and an average molecular weight |
| | Mₙ of approx. 2000 g/mol (Bayer) |
| Acclaim ® 4220: | polyether polyol containing polyoxypropylene- |
| | polyoxyethylene units (having approx. 85% primary |
| | hydroxyl groups and an average molecular weight |
| | Mₙ of approx. 4000 g/mol (Bayer) |
| Des W: | = H12-MDI: isomeric mixture of dicyclohexyl- |
| | methane diisocyanate |
| HDI: | hexamethylene diisocyanate |
| Irganox ® 1010: | tetrakis[methylene(3,5-di-tert.-butyl-4-hydroxy- |
| | hydrocinnamate)]methane (Ciba Specialty |
| | Chemicals Corp.) |
| HDO: | 1,6-hexanediol |
| BDO: | 1,4-butanediol |

Composition of the TPUs

| | HDI/Des W | | Polyol | | HDO/BDO |
|---|---|---|---|---|---|
| TPU | Mol | | Mol | | Mol |
| Comparison 1 | 1.56 | HDI | 1.0 | Terathane 1000 | 0.58 HDO |
| Comparison 2 | 2.14 | HDI | 1.0 | Terathane 2000 | 1.16 HDO |
| Comparison 3 | 3.37 | HDI | 1.0 | Acclaim 2220 | 2.4 HDO |
| Comparison 4¹⁾ | 8.7 | Des W | 1.0 | Acclaim 4220 | 7.7 BDO |
| Example 1 | 6.36 | HDI | 1.0 | Acclaim 4220 | 5.42 HDO |
| Example 2 | 9.65 | HDI | 1.0 | Acclaim 4220 | 8.75 HDO |

All TPUs contain 0.5 wt. % (based on the TPU) Irganox 1010, which was dissolved in the polyol.

All TPUs were prepared with the addition of 40 ppm DBTL, based on the polyol used.

1) This TPU was prepared with the addition of 200 ppm DBTL, based on the polyol used.

### Results

| | Tear | Elonga- | | Melting | |
|---|---|---|---|---|---|
| | strength | tion at | Hard- | point | T soft |
| TPU | Mpa | tear | ness | from DSC | (at E′ = 2 Mpa) |
| Comparison 1 | 23 | 890 | 85 | 98° C. | 108° C. |
| Comparison 2 | 30 | 845 | 80 | 133° C. | 128° C. |
| Comparison 3 | 18 | 760 | 83 | 140° C. | 130° C. |
| Comparison 4 | 9 | 530 | 80 | No peak | 125° C. |
| Example 1 | 9 | 400 | 80 | 163° C. | 147° C. |
| Example 2 | 12 | 350 | 87 | 165° C. | 155° C. |

T soft = softening temperature

### Results

It may be seen from the above Table that the TPUs according to the invention have low tear strengths accompanied by a high heat resistance (which means high melting point and high softening temperature).

The comparison TPUs, however, are either very tear-resistant and hence not usable, for example, as covering for airbags, in particular not as an invisible, integral component of the instrument panel, or are thermally less stable (Comparison 4).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic molding composition comprising a soft polyurethane prepared by reacting, optionally in the presence of (D) a catalyst,
A) a mixture of
A1) 100 to 70 mol. % hexamethylene diisocyanate (HDI) and
A2) 0 to 30 mol. % of one or more aliphatic diisocyanate other than HDI,
B) a mixture of
B1) 100 to 70 wt. % of at least one polyol having a number-average molecular weight of 2,500 to 10,000 g/mol, selected from the group consisting of polyoxypropylene glycol, polyoxyethylene glycol and copolyoxyalkylene diols based on propylene oxide and ethylene oxide and
B2) 0 to 30 wt. % of a different polyol from B1) having a number-average molecular weight of 600 to 10,000 g/mol and
C) at least one chain extender having a number-average molecular weight of 60 to 500 g/mol, said polyurethane characterized in that its equivalent ratio is 1.5:1.0 to 30.0:1.0, and its NCO index is 95 to 105.

2. The thermoplastic molding composition of claim 1 wherein the mixture B) consists of 100 percent relative to the weight of B, of B1) and the chain extender C) consists of 80 to 100 % of 1,6-hexanediol and 0 to 20 % of one or more chain extender which is different from 1,6-hexanediol and has a number-average molecular weight of 60 to 500 g/mol, the %, both occurrences being relative to the weight of C.

3. A method of using the thermoplastic molding composition of claim 1 comprising producing a molding.

4. A method of using of the thermoplastic composition of claim 1 comprising making a part by extrusion.

5. A method of using of the thermoplastic composition of claim 1 comprising making a part by injection molding.

6. A method of using of the thermoplastic composition of claim 1 comprising making a sinterable powder therefrom and producing a flat structure.

7. A method of using of the thermoplastic composition of claim 1 comprising making a sinterable powder therefrom and producing a hollow body.

8. A molded article comprising the thermoplastic molding composition of claim 1.

9. The thermoplastic molding composition of claim 1 further containing at least one member selected from the group consisting of UV stabilizers, antioxidants, lubricants, antiblocking agents, inhibitors, stabilizers against hydrolysis, heat stabilizers, discoloration stabilizers, flameproofing agents, dyes, pigments, inorganic fillers, organic fillers and reinforcing agents.
